(19) United States
(12) Patent Application Publication
(10) Pub. No.: US 2007/0041097 A1
(43) Pub. Date: Feb. 22, 2007

(54) Method for fabricating a micro-lens mold and a concave micro-lens

(76) Inventors: Jen-Chin Wu, Longtan Township (TW); Hsi-Harng Yang, Longtan Township (TW); Chia-Hua Chang, Longtan Township (TW); Chi-Haw Chian, Longtan Township (TW)

Correspondence Address: RABIN & Berdo, PC, 1101 14TH STREET, NW, SUITE 500, WASHINGTON, DC, 20005, US

(21) Appl. No.: 11/206,266

(22) Filed: Aug. 18, 2005

(51) Int. Cl. G02B 27/10

(52) U.S. Cl. 359/619

(57) ABSTRACT

A method for fabricating a micro-lens mold comprises forming a thick film on a substrate, patterning the thick film to form a micro-capillary, filling the micro-capillary with a heat curing glue liquor, rotating the substrate so that the liquid in the micro-capillary presents a circular arc shape as a micro-lens because of the surface tension of the material itself and the adhesion of the micro-capillary, and curing and shaping the heat curing glue liquor by the irradiation of a light source or by heating.

### BACKGROUND OF THE INVENTION

1. Field of Invention

The present invention relates to a method for fabricating micro-lens, and particularly to a method for fabricating micro-lens mold and concave micro-lens.

2. Related Art

In the development of photoelectric products, since the micro-optical lens can produce an optical effect in a small area, it has become a basic element greatly demanded in this industry. For example, an array of optical lenses is used in the backlight plate of a Liquid Crystal Display (LCD) to produce a uniform backlight. Moreover, the improving of photoelectric semiconductor elements, such as laser diodes, light emitting diodes, photo-detectors, a single element is substituted by an array, while its increasing application field, such as an optical computing and optical communication system, greatly needs the use of the micro-lens array. Therefore, those skilled in the art, such as manufacturers and academics, are chasing to develop the technologies of fabricating an optical micro-lens array. A brief introduction will be made below with regard to the conventional methods for fabricating a micro-lens array.

1. The Hot Melt Process:

The hot melt process is one of the methods for fabricating a refractive lens, in which a tiny cylinder of a photo-resist or polymer material is re-flowed by re-warming. When the polymer microstructure is above the glass transition temperature (Tg), the polymer material is semi-melted, and the polymeric chain between the macromolecules begins to slip, so that the polymer itself has flow ability. With the treatment at a high temperature for a long time, the microstructure will be deformed slowly by the diffusion because the microstructure is affected by semi-liquid surface tension. Finally, this material will be shaped as a semi-sphere, and thus the roughness of the surface will be improved, thereby meeting the requirements of optical grades. The disadvantage of this process is that it is necessary to use a thermoplastic polymer material, and the film made from this kind of material is typically thin, i.e., it is difficult to produce a lens with high curvature, and the mechanical properties of the material are relatively poor.

2. The Hot Press Meltback Process:

In this method, a circular mold is produced by a LIGA technology, and then is pressed to a micro-cylinder by a hot press on a polymer plastic sheet at a high pressure and temperature. The semi-sphere, formed on the top of the micro-cylinder during the hot press forming process and heating, thus fabricates a micro-lens. An advantage of the non-contact press molding is that the shapes of the finish product (semi-spherical micro-lens) and the mold (hollow cylinder) may be different, due to the hot melt effect. Thus, an approximately semi-spherical micro-lens may be obtained without a mold with a precise shape. Also, it is suggested that an optimal shape and surface of the micro-lens may be obtained at a particular draft angle of the mold. However, the disadvantage of this kind of lens is that a micro-lens with a large curvature cannot be formed, so that the numerical aperture will be diminished, and a very compact array structure cannot be produced due to the width of the mold itself.

3. The Droplets Process:

A technology similar to ink-jet printing is used in this method, in which a plurality of droplets is first sprayed onto the photo-resist layer, so as to form a reflective type micro-lens array. Also, according to this method it is difficult to control the precise appearance of the outer surface, including size, height, focus and so on.

4. The Grey-scale Mask Process:

Generally, the function of the mask used in a photolithography process is to pass or block the light source for exposure so as to achieve the purpose of replicating a pattern onto a photo-resist. However, different from the chrome (Cr)-plated mask of quartz glass which shields or transmits the exposure beam, the penetration of the exposure beam through the grey-scale mask are varied continuously. During developing, a significantly different effect of developing will be obtained due to the different exposure amount obtained by the different thicknesses of the photo-resist layer. Thus, the grey-scale mask may produce a multilevel height or continuous curved surface pattern by developing after the first exposure, and this property can also be utilized to design and fabricate a refractive micro-lens. Therefore, the fabrication cost of the grey-scale mask process is extremely high, and the cost of the bulk production cannot be reduced.

In the prior methods for mass-producing micro-lenses, take the convex lens as an example, a convex micro-lens array is obtained only by the methods of photo-resist hot melt, hot press meltback, droplet methods, then in conjunction with a concave micro-mold formed by the micro-electroforming, and finally by molding in a hot press manner. For the conventional methods for mass-producing micro-lens molds and micro-lenses, the processes are complex. Furthermore, the step of electroforming is a precise technology, and the parameters of the subsequent hot press process should also be determined carefully, thus increasing the instability of the conventional process.

### SUMMARY OF THE INVENTION

In view of the above-mentioned problems, the object of the invention is to provide a method for fabricating a micro-lens (micro-lens array) mold, in which a LIGA-like process for a thick film photo-resist are utilized along with the application of a UV-curing glue to produce a concave micro-mold directly, and then a convex micro-lens (micro-lens array) product can be molded. Alternatively, since the concave micro-mold structure employs a material with suitable optical properties, if it can be released from the substrate, it can be directly used as a concave micro-lens (micro-lens array) product. Thereby the problems present in the prior art could be substantially eliminated.

In view of the above-mentioned problems, the object of the invention is to provide a method for fabricating a concave micro-lens (micro-lens array), in which the micro-capillary (micro-capillary array) fabricated by the method described above is used as a micro-lens (micro-lens array) mold, in which a UV-curing glue is filled. A micro-lens may be formed by the surface tension of the UV-curing material and the adhesion of the capillary, which are the most natural methods for forming a lens, such, that the liquid in the capillary presents an circular arc as a micro-lens. As for the curvature of the concave shape, it will depend on the amount of the filled curing glue. Thereby substantially eliminating the problems in the prior art.

Thus, in order to achieve the above-mentioned purposes, a method for fabricating a micro-lens mold disclosed in the present invention includes forming a thick film on a substrate, patterning the thick film to form a micro-capillary, filling the micro-capillary with a heat curing glue liquor, and curing and shaping the heat curing glue liquor by the irradiation of a light source or by heating.

Thus, in order to achieve the above-mentioned purposes, a method for fabricating a concave micro-lens disclosed in the invention includes forming a thick film on a substrate, patterning the thick film to form a micro-capillary, filling the micro-capillary with a heat curing glue liquor, curing and shaping the heat curing glue liquor by the irradiation of a light source or by heating, and releasing the thick film from the substrate as a concave micro-lens.

The above steps of forming and patterning the thick film are accomplished by utilizing a LIGA technology or a LIGA-like technology.

The thick film described above is a polymer material or a photo-resist with optical properties.

Detailed characteristics and advantages of the invention will be illustrated in detail in the detailed description below, and the content is sufficient for those skilled in the art to understand and utilize the technology content of the invention, to practice the invention. Moreover, the relevant objects and advantages of the invention may be readily understood by any of those skilled in the art according to the content, claims and drawings disclosed in the specification.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus is not limitative of the present invention, wherein:

FIG. 1A is a concave micro-mold fabricated by a LIGA-like process of thick film photo-resist along with the application of a UV-curing glue;

FIG. 1B is a convex micro-lens (micro-lens array) product fabricated by utilizing the concave micro-mold in FIG. 1A;

FIG. 1C is the concave micro-mold released from the substrate in FIG. 1A, which will be used as a concave micro-lens (micro-lens array) product directly;

FIGS. 2A to 2G show a method for fabricating a concave micro-lens mold according to the invention;

FIG. 3 is a flow chart of a method for fabricating a concave micro-lens mold according to the invention;

FIGS. 4A and 4B are the SEM pictures of an completed mold with a rotational parameter of 5500 rpm, a diagonal width of a capillary opening of 100 μm, a spacing of about 10 μm;

FIG. 5 is a tendency chart of the height profile of the lens 2D in FIGS. 4A and 4B; and

FIGS. 6A and 6B are the SEM pictures of a molded product from the mold with a rotation parameter of 5500 rpm, a diagonal width of a capillary of 100 μm, a spacing of about 10 μm.

### DETAILED DESCRIPTION OF THE INVENTION

In order to illustrate the purposes, constructions, characteristics and functions of the invention, it will be described in detail below with reference to the embodiments. The abovementioned content of the invention and the detailed description below are intended to exemplify and explain the principle of the present invention, and also to provide a further explanation about the claims of the invention.

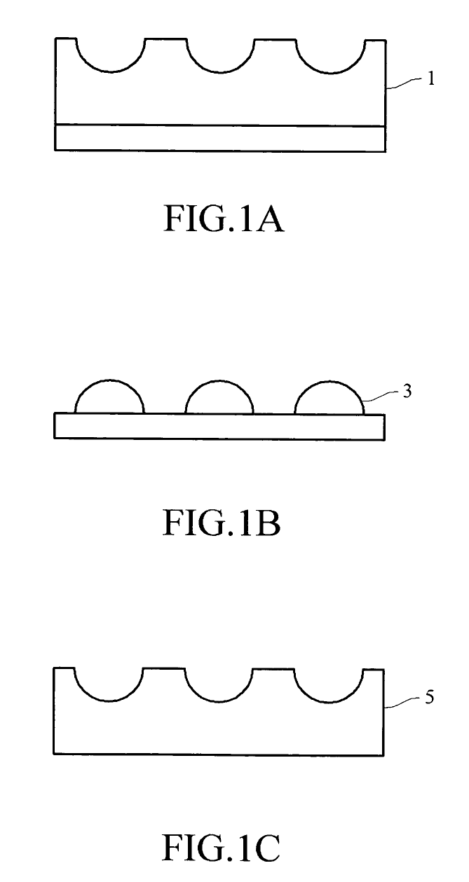

The object of the present invention is to simplify the conventional process for mass-producing micro-lens molds and micro-lenses, and to develop a new process for producing a micro-lens mold. A LIGA-like process for a thick film (photo resist) can be used along with the application of a UV-curing glue to directly produce a concave micro-mold 1 as shown in FIG. 1A, and mold a convex micro-lens (micro-lens array) product 3 as shown in FIG. 1B. Furthermore, since the concave micro-mold structure employs a material with suitable optical properties, if it can be released from the substrate, it will be directly used as a concave micro-lens (micro-lens array) product 5 as shown in FIG. 1C. “LIGA” is a German acronym for “Lithographie, Galvanoformung, Abformung”, wherein “LI” refers to the lithography, in which the synchronous irradiation X-ray is used to form a micro-structure with a height-depth-width ratio on the thick film (photo-resist). “G” stands for the technology of precise electroforming cavity, and “A” stands for the mass-producing technology of injection molding. The synchronous irradiation light source X-ray is expensive to build and difficult to obtain. In addition, not only is the fabrication of the mask complex, but also the thick film (photo-resist) material and technology are special. Therefore, an Excimer Laser is used instead of an X-ray to carry out the lithography, in order to develop the related technology of Laser LIGA of lithography molding. In a LIGA-like technology, it is necessary to first adhere a layer of dry film or coat a layer of polymer material onto a substrate, with the thickness being tens to hundreds of micrometers depending on the thickness of the work piece or the depth of the micro-structure. When the Excimer Laser is then used to process, the light source projected by a laser will be adjusted into a uniform parallel light via several lenses, then passed through the mask and the focusing lenses to process the polymer material on the substrate, so as to achieve the effect of lithography. This is the so-called laser LIGA.

According to the above conception, the invention designs an array micro-capillary structure with good transmissive optical property. This structure is made from a thick film polymer or photo-resist with optical properties and can be obtained by injecting a curable polymer flowing material with optical properties, such as UV-curing glue, heat curing glue into a micro-capillary, and forming the curing glue liquid in the micro-capillary into a circular arc as a lens, due to the surface tension effect, and then forming a concave micro-lens (micro-lens array) after curing by UV irradiation or by heating. Following this, a material with optical properties such as a polymer curing glue for molding as polydimethyl siloxane (PDMS) or a UV-curing glue may be used to mold a convex micro-lens (micro-lens array) optical film product. If necessary, the concave micro-lens (micro-lens array) master mold can also be released from the substrate, so as to be used as a concave micro-lens (micro-lens array) finish product.

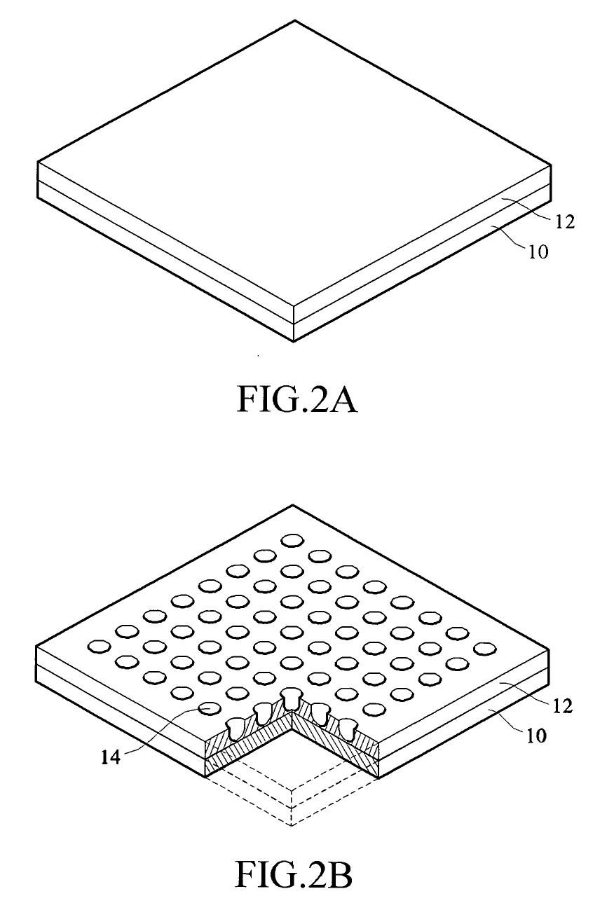

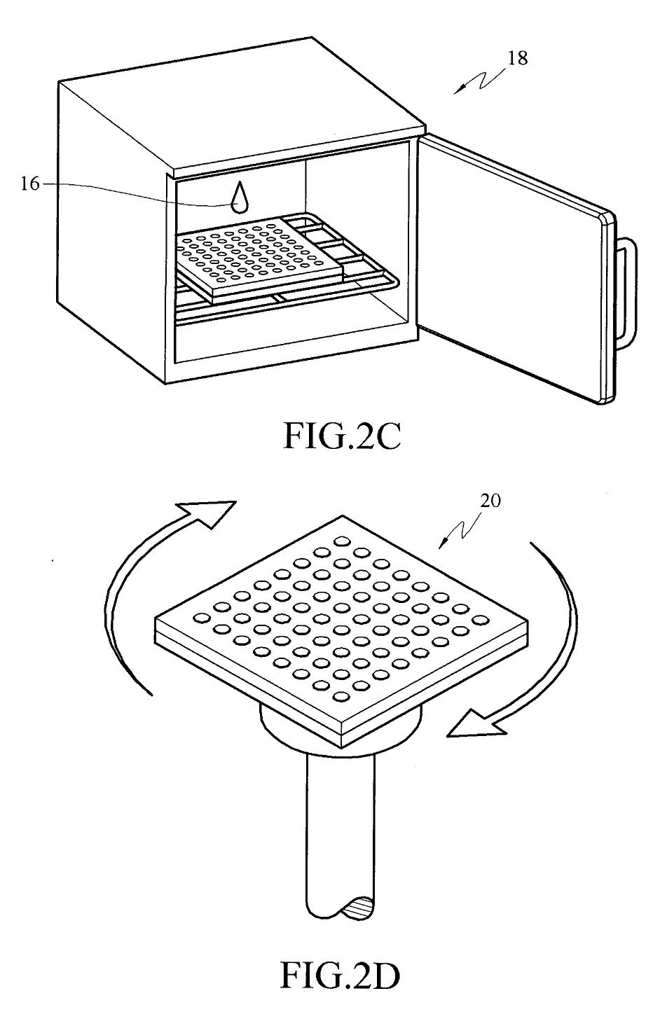

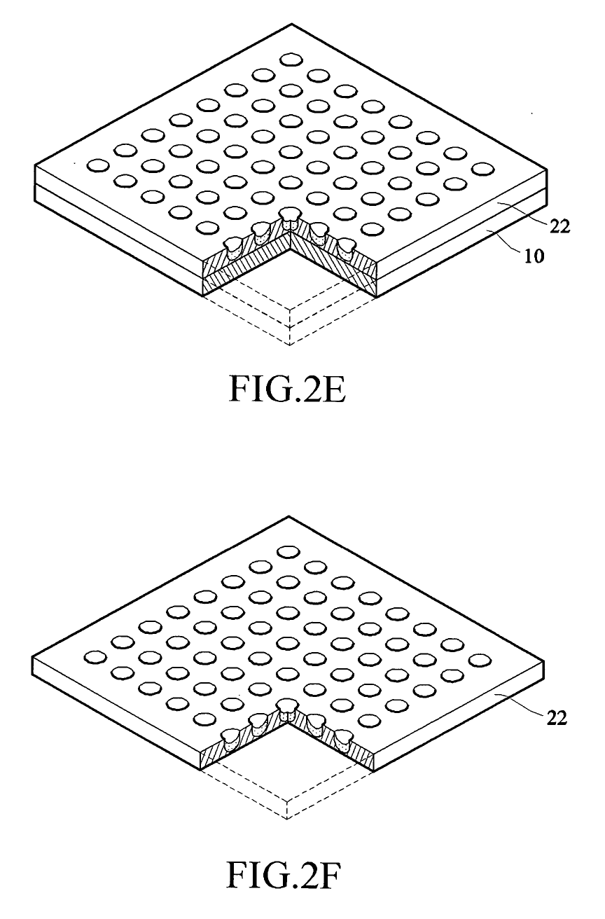

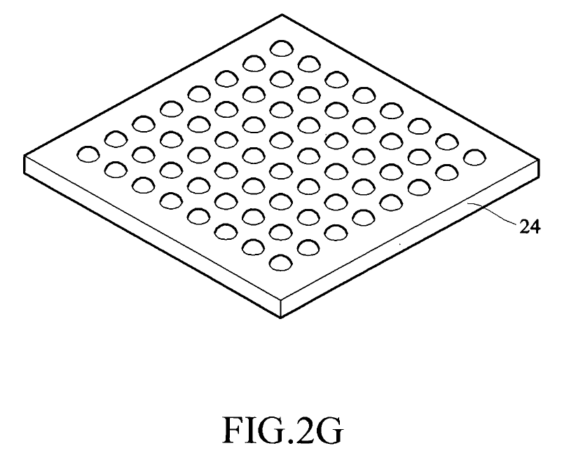

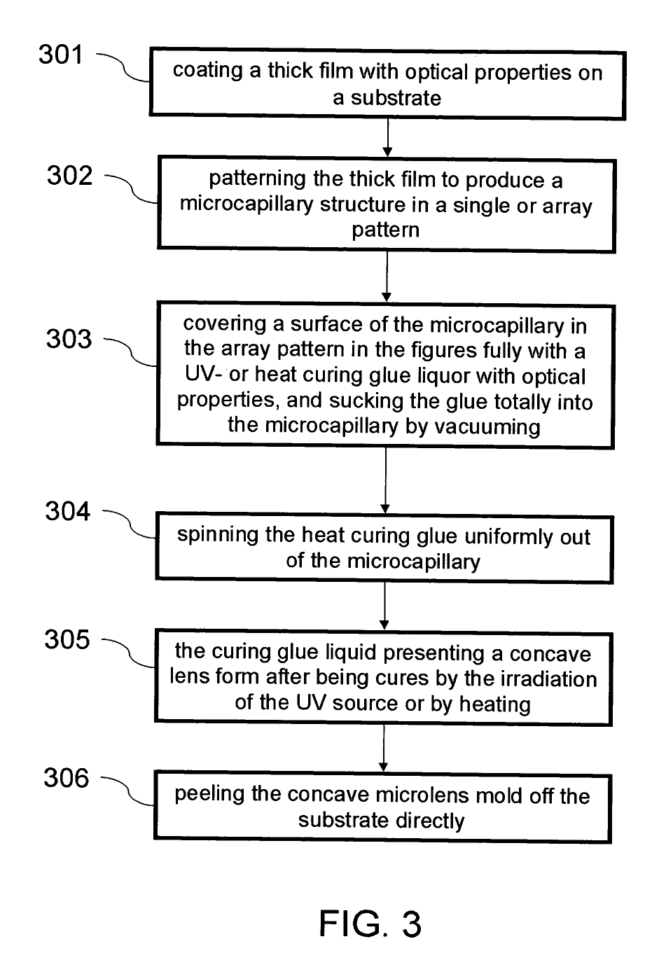

FIGS. 2A-2G show the flow of the fabrication of the present invention, and FIG. 3 is a flowchart of a method of the present invention. The implementation of the invention is as follows:

As shown in FIGS. 2A-2B, a substrate 10 is coated with a thick film 12 of optical properties thereon (step 301); the process of yellow photo lithography such as soft bake, expose, develop, and hard bake, or mechanical processing methods such as the method for processing the polymer material with laser are used to pattern the thick film so as to fabricate a micro-capillary structure 14 in a single or array pattern (step 302).

The substrate described above may be a silicon substrate.

The thick film described above may be a polymer material or a photo-resist material.

As shown in FIG. 2C, the surface of the micro-capillary in an array pattern in the figure is fully covered by a UV- or heat-curing glue liquor 16 with optical properties. The glue 16 may be totally sucked into the micro-capillary with a vacuum machine 18 by vacuuming, so as to increase the fitness between the heat curing glue liquid 16 and the micro-capillary, thus evacuating the gases pre-existing in the micro-capillary (step 303).

As shown in FIG. 2D, the UV- or heat curing glue is then spun uniformly out of the micro-capillary with a spin-coater 20 by way of spinning, and the curvature of the concave shape depends on the amount of the heat curing glue liquid 16 remained in the micro-capillary (step 304).

As shown in FIG. 2E, the surface of the curing glue liquid is formed into a concave shape due to the phenomenon in the micro-capillary, and after curing by the irradiation of the UV source or by heating, this curing glue liquid presents a concave lens form 22, which may be used as a concave micro-lens mold (step 305).

As shown in FIG. 2F, the concave micro-lens mold 22 is peeled off the substrate 10 directly, and may be utilized to mold a convex micro-lens product 24 directly or along with a material with optical properties, such as a polymer curing glue for molding as polydimethyl siloxane (PDMS) or a UV-curing glue (step 306).

By utilizing changes of the surface tension of the photo-resist material itself and the adhesion of the micro-capillary, micro-lenses or micro-lens, arrays with different curvatures are obtained, and the formed micro-lenses may be cured by the UV light, which is the most convenient method for forming a lens.

With regard to the experiments of the invention, when it is desired to design a micro-capillary structure in an array pattern, since a hexagonal column can produce an array structure that is more closed (no seam) than a circular micro-capillary, i.e. a cellular structure, the design of a hexagonal micro-capillary array is employed in the experiments of the invention. In order to facilitate the experiments to prove the feasibility, two structures with diagonals of the hexagonal micro-capillary openings of 100 μm and 75 μm are respectively designed depending upon the different sizes, and additionally four sizes with spacing of 5 μm, 10 μm, 15 μm, and 20 μm are respectively designed depending upon the different gaps, i.e. wall thickness of the micro-capillary. Furthermore, while the UV-curing glue is spun, different spinning speeds are varied, which are three spinning speeds of 4500 rpm, 5000 rpm, 5500 rpm respectively in this experiment. This is done to seek for their effects on the subsequent process of forming the cavity of the concave micro-lens array at these three parameters.

Herein, the three experimental parameters are again listed out for illustration below.

(1) When the UV-curing glue is spun, different spinning speeds are varied, which are three spinning speeds of 4500 rpm, 5000 rpm, 5500 rpm respectively in this experiment, so as to seek for the effect of the spinning speed on its subsequent forming.

(2) In the process of yellow light, the mask design described above is used to make different spacing between the micro-capillary arrays being approximately 5 μm, 10 μm, 15 μm and 20 μm respectively, so as to seek for its effect on the subsequent forming at different spacing.

(3) The diagonal width of the hexagonal micro-capillary array is varied, to be openings of 75 μm and 100 μm respectively to seek its effect on the subsequent forming at different diagonal widths of the micro-capillary.

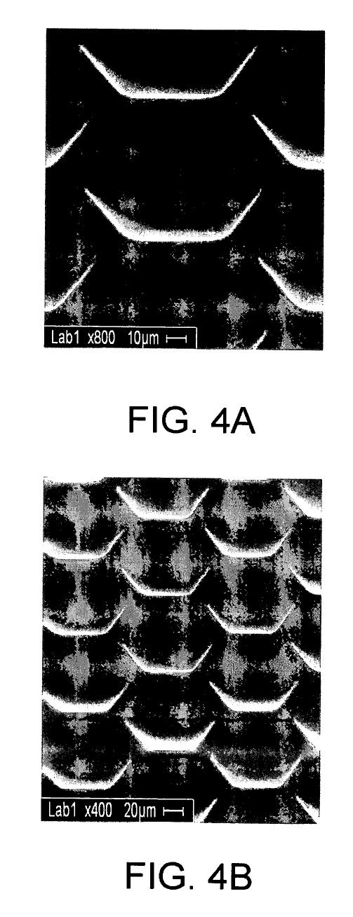

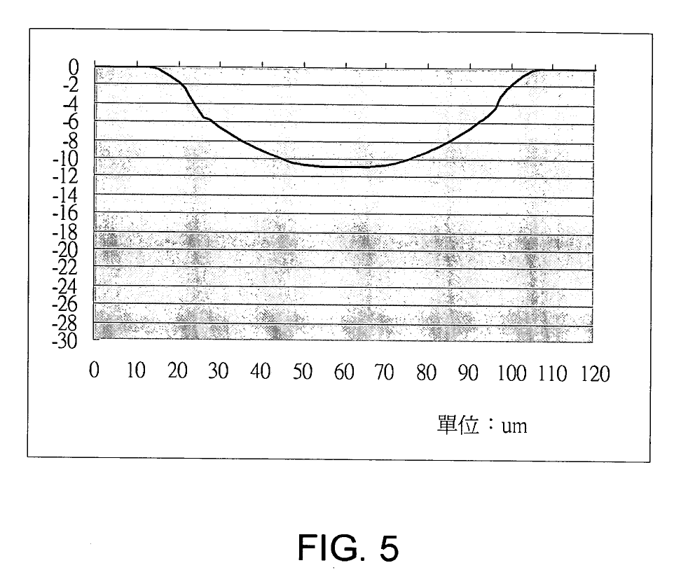

FIGS. 4A and 4B are the SEM pictures of a completed mold having a spinning parameter of 5500 rpm, a diagonal width of a micro-capillary opening of 100 μm, a spacing of about 10 μm, and FIG. 5 is a tendency chart of the height profile of the lens 2D.

The radius of curvature (Rc) and the focus (f) are calculated respectively for each of the completed concave lens molds fabricated at the parameters by the depth (h) and the diameter (D) of the concave hole measured and the refractive index (n) of the curing glue, by the following formula (1) and (2)

$$\begin{matrix}Rc = \frac{{h}^{2} + \frac{{D}^{2}}{4}}{2 h} \\ and & ( 1 ) \\ f = \frac{R}{n - 1} & ( 2 )\end{matrix}$$

Measurement results of the parameters in the experiments are shown in the tables 1 and 2 below, while the calculation results of the radius of the curvature are shown in the tables 3 and 4 below.

TABLE 1

diagonal length, 100 μm
h: height of concave microlens (sag), μm
spacing

| spinning speed | 5 μm | 10 μm | 15 μm | 20 μm |
|---|---|---|---|---|
| 5500 rpm | 10.82 | 10.3 | 8.31 | 7.3 |
| 5000 rpm | 9.17 | 8.84 | 5.92 | 4.44 |
| 4500 rpm | 7.69 | 4.78 | 2.8 | 2.3 |

TABLE 2

diagonal length, 75 μm
h: height of concave microlens (sag), μm
spacing

| spinning speed | 5 μm | 10 μm | 15 μm | 20 μm |
|---|---|---|---|---|
| 5500 rpm | 10.02 | 9.03 | 6.3 | 3.78 |
| 5000 rpm | 7.76 | 5.97 | 3.98 | 2.66 |
| 4500 rpm | 4.16 | 3.9 | 2.13 | 1.36 |

TABLE 3

| | diagonal length, 100 μm | | | |
|---|---|---|---|---|
| | R: radius of curvature of concave microlens, μm | | | |
| | spacing | | | |
| spinning speed | 5 μm | 10 μm | 15 μm | 20 μm |
| 5500 rpm | 98.98671 | 103.451 | 125.9962 | 142.3486 |
| 5000 rpm | 114.9994 | 118.9562 | 173.9904 | 230.2605 |
| 4500 rpm | 135.5095 | 214.2101 | 363.0071 | 441.3674 |

TABLE 4

| | diagonal length, 75 μm | | | |
|---|---|---|---|---|
| | R: radius of curvature of concave microlens, μm | | | |
| | spacing | | | |
| spinning speed | 5 μm | 10 μm | 15 μm | 20 μm |
| 5500 rpm | 49.92018 | 54.34889 | 74.57857 | 120.9376 |
| 5000 rpm | 61.86969 | 78.36188 | 115.0553 | 170.5029 |
| 4500 rpm | 110.2531 | 117.3346 | 212.3326 | 331.5624 |

From the results of the experiments of the invention, the tendency may be apparent to those skilled in the art and is summarized as follows:

(1) with the same spinning speed of the glue and the same spacing of the hexagonal micro-column of the array, if the diagonal length of the hexagonal micro-column opening is larger, the concave micro-lens will be deeper, i.e., the micro-lens is higher after being molded.

(2) with the same spacing of the hexagonal micro-column and the same diagonal opening length of the hexagonal micro-capillary, it will be apparent that if the spinning speed of the glue is faster, the concave micro-lens will be deeper.

(3) with the fixed spinning speed of the glue and the fixed diagonal opening length of the hexagonal micro-capillary, if the spacing of the hexagonal micro-column array is smaller, the concave micro-lens will be deeper.

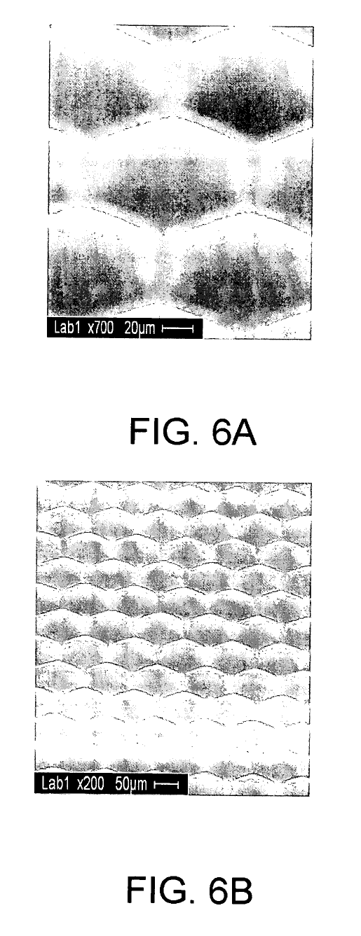

In addition to those basic measurements, observation for molding is also a good method to determine the quality of the shape of a mold. However, the present invention is not intended to discuss the conception of the subsequent molded final product, but to discuss whether the geometrical shape of the mold has achieved the expected shape of a micro-lens by using the molded final product, to observe and demonstrate the feasibility and integrity of the invention, in conjunction with background and summary of the invention described above. Therefore, a material with optical properties such a polymer curing glue for molding as a PDMS or a UV-curing glue is used for molding. FIGS. 6A and 6B are the SEM pictures of a molded product from the mold having a spinning parameter of 5500 rpm, a diagonal width of the micro-capillary of 100 μm and a spacing of approximately 10 μm.

The benefits/advantages achieved in the present application include:

(1) Mass Replication:

By utilizing the present invention, array micro-lens molds can be mass-produced directly, and convex micro-lens or convex micro-lens array products can be molded with a polymer material such as a PDMS or a UV-curing glue, with or without the electroforming molding step. Moreover, since the micro-lens mold structure employs a material with suitable optical properties, if it is released from the substrate, it can also be used as a concave micro-lens or concave micro-lens array product.

(2) An Extremely Simple Process:

The shape and size of the micro-lens mold may be stably controlled by the spinning speed of the curing glue, the spacing between the micro-capillary arrays, and the opening size of the micro-capillary array.

(3) Low Cost of Production Equipment:

The invention employs a cheap spinner, vacuum equipment and heating plate or UV irradiation lamp, used for curing glue other than complex and expensive production equipment.

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for fabricating a micro-lens mold, comprising:
forming a thick film on a substrate;
patterning the thick film to form a micro-capillary;
filling the micro-capillary with a heat curing glue liquor; and
curing and shaping the heat curing glue liquor.

2. The method for fabricating a micro-lens mold of claim 1, wherein the steps of forming and patterning the thick film are accomplished by utilizing a LIGA technology or a LIGA-like technology.

3. The method for fabricating a micro-lens mold of claim 1, wherein the step of filling the micro-capillary with the heat curing glue liquor further comprises:
dripping the heat curing glue liquor onto a surface of the micro-capillary; and
sucking the heat curing glue liquor into the micro-capillary by vacuuming.

4. The method for fabricating a micro-lens mold of claim 1, wherein a step of rotating the substrate is further contained between the step of filling the micro-capillary with the heat curing glue liquor and the step of curing and shaping.

5. The method for fabricating a micro-lens mold of claim 4, wherein the spinning speed and the viscosity coefficient of the curing glue may be changed in any way.

6. The method for fabricating a micro-lens mold of claim 1, wherein the step of curing and shaping the heat curing glue liquor is accomplished by utilizing the irradiation of a light source or by heating.

7. The method for fabricating a micro-lens mold of claim 1, wherein the thick film is a polymer material with optical properties.

8. The method for fabricating a micro-lens mold of claim 1, wherein the thick film is a photo-resist.

9. The method for fabricating a micro-lens mold of claim 1, wherein the substrate is a silicon substrate.

10. The method for fabricating a micro-lens mold of claim 1, wherein the micro-capillary is hexagonal.

11. The method for fabricating a micro-lens mold of claim 1, wherein the heat curing glue liquor is a curable polymer flowing material with optical properties.

12. The method for fabricating a micro-lens mold of claim 1, wherein the light source is a UV source.

13. A method for fabricating a concave micro-lens, comprising:
forming a thick film on a substrate;
patterning the thick film to form a micro-capillary;
filling the micro-capillary with a heat curing glue liquor;
curing and shaping the heat curing glue liquor; and
releasing the thick film from the substrate to be a concave micro-lens.

14. The method for fabricating a concave micro-lens of claim 13, wherein the steps of forming and patterning the thick film are accomplished by utilizing a LIGA technology or a LIGA-like technology.

15. The method for fabricating a concave micro-lens of claim 13, wherein the step of filling the micro-capillary with the heat curing glue liquor further comprises:
dripping the heat curing glue liquor onto a surface of the micro-capillary; and
sucking the heat curing glue liquor into the micro-capillary by vacuuming.

16. The method for fabricating a concave micro-lens of claim 13, wherein a step of rotating the substrate is further contained between the step of filling the micro-capillary with the heat curing glue liquor and the step of curing and shaping.

17. The method for fabricating a concave micro-lens of claim 13, wherein the step of curing and shaping the heat curing glue liquor is accomplished by utilizing the irradiation of a light source or by heating.

18. The method for fabricating a concave micro-lens of claim 13, wherein the thick film is a polymer material with optical properties.

19. The method for fabricating a concave micro-lens of claim 13, wherein the thick film is a photo-resist.

20. The method for fabricating a concave micro-lens of claim 13, wherein the substrate is a silicon substrate.

21. The method for fabricating a concave micro-lens of claim 13, wherein the micro-capillary is hexagonal.

22. The method for fabricating a concave micro-lens of claim 13, wherein the heat curing glue liquor is a curable polymer flowing material with optical properties.

23. The method for fabricating a concave micro-lens of claim 13, wherein the light source is a UV source.
